(19) United States
(12) Patent Application Publication
(10) Pub. No.: US 2012/0021363 A1
(43) Pub. Date: Jan. 26, 2012

(54) Co-Crystals and Their Use

(76) Inventor: Anthony Jarvis, Cheshire (GB)

(21) Appl. No.: 13/145,444

(22) PCT Filed: Feb. 4, 2010
(86) PCT No.: PCT/GB10/50170

§ 371 Date: Jul. 20, 2011

(30) Foreign Application Priority Data
Feb. 5, 2009 (GB) 0901964.7
Apr. 2, 2009 (GB) 0905785.2

(51) Int. Cl. G03C 7/46

(52) U.S. Cl. 430/374; 430/357; 430/541

(57) ABSTRACT

A method of forming an image on a substrate by irradiation thereof, wherein the substrate comprises therein or thereon a co-crystal of a polymerisable unsaturated monomer and a spacing component, wherein the co-crystal is capable of undergoing a radiation-activated colour change reaction. A co-crystal of a diacetylene and a spacing component, whereby the reactivity of the diacetylene is reduced is also provided, together with a surface coating composition comprising this co-crystal.

### FIELD OF THE INVENTION

This invention relates to co-crystals and their use.

### BACKGROUND OF THE INVENTION

Certain unsaturated compounds such as diacetylenes are known to undergo a light-activated colour change reaction when exposed to, for example, UV radiation. Polyacetylenes that are useful in colour change reactions are disclosed in U.S. Pat. No. 4,705,742, WO2006/018640 and PCT/GB2009/000174. An example of such a diacetylene is 10,12-pentacosadiynoic acid.

The mechanism of the colour change reaction involves the formation of a conjugated polymer network via the topochemical polymerisation of the diacetylene group. However, the presence of a diacetylene moiety —C≡C—C≡C— in a molecule does not necessarily mean that polymerisation and colour formation will occur. The topochemical requirements for the polymerisation of diacetylenes are disclosed by V. Enklemann in Structural Aspects of the Topochemical Polymerization of Diacetylenes, Advanced Polymer Science, 1984, 63, 91-136. This reference is incorporated herein in its entirety. Enklemann discloses that an intermolecular repeat distance, d, of approximately 490 picometres, and a tilt angle, φ of approximately 44° from the axis, bring the 1-4 carbons of adjacent diacetylene groups into near van der Waals contact, as is required for polymerisation.

U.S. Pat. No. 6,417,245 discloses a method for preparing a conjugated polymer comprising a host molecule and a guest conjugated monomer, wherein the host molecule and guest conjugated monomer form a co-crystal in which the conjugated monomer has the correct intermolecular distance and tilt angle needed to polymerise. Indeed, in its pure form the guest conjugated monomer is incapable of polymerisation.

U.S. Pat. No. 6,417,245 describes the polymerisation of polyacetylenes, including diacetylenes, as conjugated monomers. The only specific examples relate to triacetylenes whose reactivity, i.e. propensity to polymerise, is enhanced by provision in a suitable co-crystal.

### SUMMARY OF THE INVENTION

The present invention is based in part on an application of how the effects reported in U.S. Pat. No. 6,417,245B1 can be controlled and utilised to achieve effective image formation and colouration enhanced by provision in a suitable co-crystal colouration.

The present invention is based on the surprising finding that a co-crystal comprising a polymerisable unsaturated monomer and a spacing component are capable of undergoing a radiation-activated colour change reaction. The co-crystal's radiation-induced colour change reaction can be used as the basis for image formation in printing applications and in the colouration of substrates. In the present invention, the spacing component is chosen to modify the reactivity of the colour-forming polymerisable unsaturated monomer, thereby tailoring its reactivity to meet the specific needs of the application.

In certain applications, low reactivity is required. Thus a spacing component is selected that reduces the tendency of the unsaturated monomer to polymerise under ambient conditions. In other applications, an increase in reactivity is required. This might be required of certain unsaturated compounds that would not normally polymerise but can be co-crystallised into a system that will react. These unsaturated compounds may have other properties or give rise to co-crystals that are more suitable for the application in question rather than the known self-polymerising equivalents.

### DESCRIPTION OF PREFERRED EMBODIMENTS

Preferred polymerisable unsaturated monomers suitable for use in the invention are conjugated polyacetylenes such as diacetylenes comprising the structure —C≡C—C≡C— and triacetylenes comprising the structure —C≡C—C≡C—C≡C—. Particularly preferred polyacetylenes are those that are capable of exhibiting multiple colours. Certain diacetylenes for example turn blue on exposure to UV light followed by purple, red, orange and yellow and further exposure.

Examples of systems in which a co-crystal is formed from an polymerisable unsaturated monomer, which in its pure form is incapable of polymerisation, are disclosed in U.S. Pat. No. 6,417,245. Further examples are given in Lauher et al. “Single crystal to single crystal topochemical polymerization by design”, Acc. of Chem. Res. vol. 41, No. 9 (September 2008), pp. 1215 to 1229.

In these examples, the polymerisable unsaturated monomer is linked via hydrogen bonds to a spacing component and is held at the right distance and tilt angle for topochemical polymerisation to occur. Particularly preferred polymerisable monomers are polyacetylenes such as di- and tri-acetylenes that possess groups capable of forming supramolecular bonds such as dipole-dipole and hydrogen bonds. Particularly preferred polyacetylenes are those that possess groups comprising highly electronegative elements such as N or O. Examples of such groups include, but are not limited to, OH, COOH, ester, amide, thiol, thioester, pyridyl, phenolic, NHR, NH₂, but also halogen and terminal acetylene-H. Also preferred are spacing components comprising ionic or ionisable groups.

Particularly preferred diacetylene compounds are “activatable”—i.e. in their initial solid form are unreactive to UV light, and in this initial form are essentially incapable of undergoing light induced colour change reactions. However, when said diacetylene compounds are, for example melted and re-solidified, they transform into a solid form that is highly reactive to UV light and will subsequently undergo light induced colour change reactions: colourless to blue to magenta, to red to orange to yellow.

Particularly preferred diacetylenes are those that after initial melting and re-solidification activation are colourless but become blue on exposure to light, particularly UV light. The most preferred diacetylenes compounds are carboxylic acids and derivatives thereof where:

R—C≡C—C≡C—R′

either R and/or R′ comprises a COX group,
where X is: —NHY, —OY, —SY, where Y is H or any group comprising at least one carbon atom.

Particularly preferred still are derivatives in which the carboxylic acid group has been functionalised into an amide, ester or thioester. These can be easily made by reacting a diacetylene carboxylic acid with a chlorinating agent such as oxalyl chloride and then reacting the diacetylene acid chloride with a nucleophilic compound such as an amine, alcohol or thiol. A particularly preferred diacetylene carboxylic acid compound is 10,12-docosadiyndioic acid and derivatives thereof such as amides, esters, thioesters and the like. Amides are particularly preferred. Especially particularly preferred 10,12-docosadiyndioic acid derivatives are amides. A particularly preferred still 10,12-docosadiyndioic acid amide derivative is the propargylamide in which at least one, preferably both carboxylic acid groups have been transformed into the propargylamide (FIG. 1).

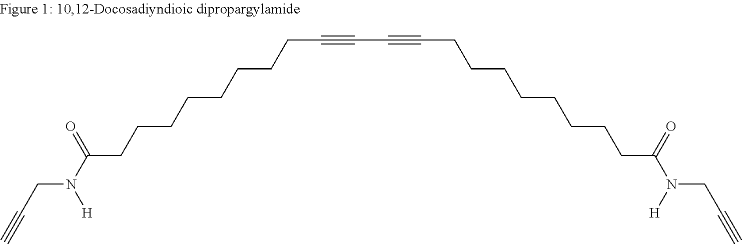

Propargylamides are made by reacting carboxylic acids with propargylamime. Other preferred amines that can be used to create suitable amides include: dipropargylamine and 1,1-dimethylpropargylamine.

A photo or thermal acid or base-generating compound can be used to add or remove charge to a system, which in turns causes either an increase in reactivity or a decrease in reactivity to a change in bond length, d, or tilt angle, φ, caused by electrostatic repulsion or attractions. Suitable photo acid-generators include “onium” type compounds such as iodonium and sulphonnium types.

Preferred spacing components are those capable of forming supramolecular bonds to the polymerisable unsaturated monomer; particularly preferred are those capable of forming dipole-dipole and hydrogen bonds. Examples include oxalamides, vinylogous amides, isocytocines, aminopyridones, aminoquinones and ureas. Particularly preferred are oxalamides, and most preferred are oxalamide-amino acid compounds such as the oxalamide of glycine.

By selecting the right combination of polyacetylene and spacing component, the reactivity of the co-crystal can be fine-tuned to the needs of the specific application in question.

It may be the case that a polyacetylene rather than being unreactive or of too low reactivity when pure is actually too reactive. 10,12-pentacosadiynoic acid, for example, as is well known, rapidly forms a blue colour upon exposure to UV light, via a topochemical polymerisation reaction, without the need for a spacing component. It may alternatively be the case that a particular application requires a reduction in reactivity, for example where high light stability is required. Thus a spacing component is employed, to give a co-crystal that is of lower overall reactivity than the pure monomer. It is believed that the spacing group separates or tilts the polymerisable unsaturated monomers to such an extent that their reactivity is reduced. Again, the spacing component can be used to fine-tune the reactivity of the polymerisable unsaturated monomer, thereby increasing its usefulness in a particular application. For example, where light stability is required in an application that employs a highly reactive light-activated colour-forming unsaturated monomer, such as a diacetylene like 10,12-pentacosadiynoic acid, the spacing component can be used to reduce reactivity by increasing the diacetylene intermolecular distance or introducing a less favourable tilt angle. However, under intense radiation exposure, such as that provided by a laser, polymerisation still occurs, to produce a colour change reaction.

It is also possible for the colour-forming polymerisable unsaturated monomer and spacing component to be part of the same molecule. The molecule may form self-complementary supramolecular bonds, in the solid state. It is particularly preferred if the colour-forming polymerisable monomer is polyacetylenic such as a diacetylene or a triacetylene and the spacing component is capable of forming intermolecular hydrogen bonds.

The intermolecular spacing distance and tilt angle of colour-forming unsaturated monomers can be modified if complexed with a species such as a metal ion, e.g., a transition metal ion. In this case, the colour-forming unsaturated monomer includes a group capable of forming a coordinate bond to a metal ion.

Co-crystals of the present invention must be capable of undergoing a radiation-induced colour change reaction. This forms the basis of their use in imaging and colouration applications. Imaging in this context is the formation of text, characters, logos, codes such as machine-readable codes, for examples barcodes, decorative effects, indicia, symbologies, devices, pictures and the like, on or in a substrate, using radiation. The co-crystals or components thereof can be used to impart coloration to substrates like traditional dyes and pigments but have the advantage of radiation activation and polychromism. The co-crystals can be applied either pre-made or the components can be applied and the co-crystals formed in situ within or on the substrate. The co-crystals or the components thereof can be formulated into a surface-coating formulation such as an ink and applied to the substrate using any known printing application technique. The substrate can be any known substrate, e.g. paper, card, corrugate or board, textiles, plastic parts, plastic films, glass, metals, tin or foils. The substrate may be a data carrier such as a CD or DVD. Other examples include edibles such as foodstuffs and pharmaceutical unit dose preparations such as tablets and pills.

The co-crystals or the components thereof can be formulated into the bulk of a substrate such as plastic parts or films, e.g. using an injection moulding or extrusion technique. Paper or textiles, with the co-crystals or components thereof embedded into the fibrous structure rather than coated on to the surface, are further embodiments of the invention.

The radiation used to activate the colour change reaction can be in the wavelength range 200 nm to 20 μm. It can be laser or non-coherent radiation, monochromatic or broadband. Lasers are particularly useful as they can be computer-controlled, to draw precise images on to a substrate. However, non-coherent radiation in combination with a mask can also be used to produce images on a substrate.

The substrate can also comprise one or more other substances that are commonly applied to substrates, such as dyes/pigments, UV, NIR or mid-IR absorbers, anti-microbials, binders, whitening agents such as TiO₂, optical brighteners, thermal or photo acid-generating agents, other colour-formers such as leuco dyes, charge-transfer agents, molybdates such as ammonium octamolybdate, sodium metaborate, radical generators, radical quenchers/scavengers, softening agents, sizes, anti-slip agents, gas diffusion barriers and the like.

The radiation-activated colour-forming co-crystals of the present invention and substrates comprising them can be used in any application where image formation and colouration are required. Examples include, but are not limited to, printing, particularly digital inkless printing on paper-based or plastic-based substrates, bulk plastics colouration, textile colouration and printing, colour filter formation, particularly colour filters for use in displays such as LCDs and the like, security applications, and optical recording disks.

The following Examples illustrate the invention.

### Example 1

5,7-Dodecadiyne-1,12-diol and the oxalamide of glycine

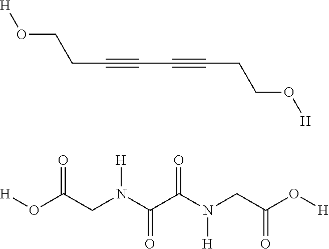

were applied to paper in two different ways:
a. Via a surface coating ink formulation with a binder,
b. Incorporated into the bulk of the paper during the manufacturing stage.

A 266 nm coherent UV laser control by an IBM-compatible PC was used to write text, and draw images and machine readable codes on to the two substrates.

A non-coherent broadband UV curing machine fitted with a mask was used to create readable text and images.

### Example 2

A triacetylene dicarboxylic acid and a vinylogous amide with a pyridine pendant group

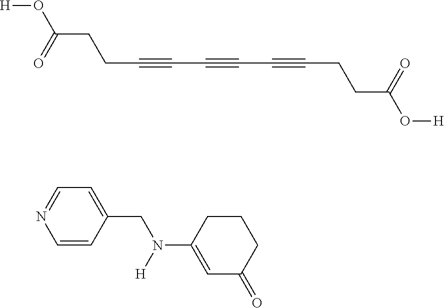

were applied to paper in two different ways:
a. Via a surface coating ink formulation with a binder,
b. Incorporated into the bulk of the paper during the manufacturing stage.

A 266 nm coherent UV laser control by an IBM-compatible PC was used to write text, and draw images and machine readable codes on to the two substrates.

A non-coherent broadband UV curing machine fitted with a mask was used to create readable text and images.

### Example 3

The co-crystals described in Example 1 were applied to PE and PP using an injection-moulding process. A UV lamp was used to impart colour to the resultant plastic part.

### Example 4

The co-crystals described in Example 2 were applied to PP using an injection moulding process. A UV lamp was used to impart colour to the resultant plastic part.

### Example 5

The co-crystals described in Example 1 were used to produce a blue plastic film that was used to produce a colour filter for an LCD display device.

### Example 6

The co-crystals described in Example 2 were used to construct an optical recording disk.

### Example 7

10,12-Pentacosadiynoic acid and the oxalamide of glycine were applied to paper in two different ways:
a. Via a surface coating ink formulation with a binder,
b. Incorporated into the bulk of the paper during the manufacturing stage.

A 266 nm coherent UV laser control by an IBM-compatible PC was used to write text, and draw images and machine readable codes on to the two substrates in multi-colours.

A non-coherent broadband UV curing machine fitted with a mask was used to create readable text and images in multi-colours.

The co-crystal was found to have less reactivity than the same system comprising just 10,12-pentacosadiynoic acid.

### Example 8

10,12-Pentacosadiynoic acid and the oxalamide of glycine were injection moulded into PE and PP.

A 266 nm coherent UV laser control by an IBM compatible PC was used to write text, and draw images and machine readable codes on to the two plastic parts in multi-colour.

A non-coherent broadband UV curing machine fitted with a mask was used to create readable text and images in the plastic parts and impart bulk colouration in multi-colour.

The co-crystal was found to have less reactivity than the same system comprising just 10,12-pentacosadiynoic acid.

### Example 9

10,12-Docosdiyndioic dipropargylamide—was formulated into an ink with a binder and a NIR absorbing agent. The ink was coated onto a CD and DVD. A NIR laser was then used to activate specific regions of the coated disk to be coloured and a UV light source such as a laser or lamp used to turn the NIR activated areas blue. The NIR laser was then used to turn the blue areas red to create a multi-coloured image.

1. A method of forming an image on a substrate by irradiation thereof, wherein the substrate comprises therein or thereon a co-crystal of a polymerisable unsaturated monomer and a spacing component, wherein the co-crystal is capable of undergoing a radiation-activated colour change reaction.

2. The method as claimed in claim 1, wherein the co-crystal is less reactive than the unsaturated monomer.

3. The method as claimed in claim 1, wherein the co-crystal is more reactive than the unsaturated monomer.

4. The method as claimed in claim 3, wherein the unsaturated monomer is not directly polymerisable without the spacing component.

5. The method as claimed in claim 1, wherein the unsaturated monomer is a polyacetylene.

6. The method as claimed in claim 5, wherein the polyacetylene is a diacetylene, triacetylene or tetraacetylene.

7. The method as claimed in claim 1, wherein the unsaturated monomer and the spacing component are bonded by inter-molecular bonds.

8. The method as claimed in claim 8, wherein the inter-molecular bonds are hydrogen bonds.

9. The method as claimed in claim 8, wherein the intermolecular bonds are ionic bonds.

10. The method as claimed in claim 1, wherein the unsaturated monomer and the spacing component are part of the same molecule.

11. The method as claimed in claim 1, wherein the unsaturated monomer is co-ordinately bonded to a metal atom.

12. The method as claimed in claim 1, wherein, in the co-crystal, adjacent monomers are spaced at a distance of 2.5 to 10 A, and orientated at an angle of 25 to 65°.

13. The method as claimed in claim 1, wherein the image is coloured.

14. The method as claimed in claim 13, wherein the image comprises at least two colours.

15. The method as claimed in claim 1, wherein the substrate is a plastic part, used in printed applications, part of a display device, part of an optical recording disk, or a textile.

16. A co-crystal of a diacetylene and a spacing component, whereby the reactivity of the diacetylene is reduced.

17. A surface coating composition comprising a co-crystal according to claim 16.
